(19) United States
(12) Patent Application Publication
(10) Pub. No.: US 2024/0351919 A1
(43) Pub. Date: Oct. 24, 2024

(54) PROCESS AND APPARATUS FOR CONTINUOUS PRODUCTION OF ULTRAPURE WATER, USE THEREOF AND DEVICE FOR CUTTING OF PARTS

(71) Applicants: BUERKERT WERKE GMBH & CO. KG, Ingelfingen (DE); BURKERT SINGAPORE PTE LTD, Singapore (SG)

(72) Inventor: Beng Huat NEOH, Singapore (SG)

(21) Appl. No.: 18/720,111

(22) PCT Filed: Dec. 14, 2022
(86) PCT No.: PCT/EP2022/085913

§ 371 Date: Jun. 14, 2024

(30) Foreign Application Priority Data
Dec. 15, 2021 (DE) 10 2021 133 311.3

(51) Int. Cl. C02F 1/68; C02F 103/02; C02F 103/04

(52) U.S. Cl. CPC C02F 1/685; C02F 2103/023; C02F 2103/04; C02F 2201/005; C02F 2209/003; C02F 2209/05; C02F 2209/38; C02F 2301/022; C02F 2301/08

(57) ABSTRACT

The invention relates to a process for the continuous production of ultrapure water from a continuous stream of high-purity water by adding gas to the continuous flow of water. The gas is admixed in two successive steps and, after each step, the electrical conductivity and/or an electrical resistance of the water-gas solution is measured to control the amount of gas supplied and to achieve target values. The invention also relates to a use of a continuous stream of ultrapure water generated by the process. Furthermore, the invention relates to an apparatus for the continuous production of ultrapure water and for carrying out the process. In addition, a device for the cutting of parts is described.

### FIELD OF DISCLOSURE

The present disclosure relates to a process and an apparatus for the continuous production of ultrapure water. The present disclosure further relates to a use of the ultrapure water and a device for cutting of parts.

### BACKGROUND

In the mechanical machining of parts, in particular in mechanical sawing, it is necessary to provide cooling by means of a coolant. If high demands are made here on the process step of mechanical machining in terms of accuracy and purity, this also has to be taken into account when selecting the coolant or coolant composition. In such cases, a coolant based on specially treated and purified water is typically resorted to. This contributes to ensuring that no impurities are left on the part to be machined and makes sure that the part remains at least to a large extent free of corrosion.

In the present case, a distinction is made between high-purity water and ultrapure water. The definition of high-purity water and ultrapure water is made on the basis of electrical conductivity, which forms a sum parameter and constitutes a representative value for the purity of water in technical areas.

Water that has an electrical conductivity in the range of from 0.05 μS/cm to less than 0.2 μS/cm at a temperature of 25 degrees C. is referred to as high-purity water here. Water having an electrical conductivity in a range of from 0.2 μS/cm to 10 μS/cm at a temperature of 25 degrees C. is regarded as ultrapure water.

Alternatively, the definition of high-purity water and ultrapure water can also be made on the basis of the electrical resistance. The electrical resistance is formed from the reciprocal of the electrical conductivity.

Both the high-purity water and the ultrapure water are usually demineralized, degassed and freed from a large portion of the ions (using a membrane process, for example).

During a mechanical machining of parts, in particular during mechanical sawing, a static charge can build up due to ions being released. This is the case, for example, in the manufacture of semiconductors and the associated sawing to size of disk-shaped wafers. This static charge may cause chips produced during sawing to adhere to the part to be machined. This may have an adverse effect on quality and the parts to be machined may possibly even be damaged.

These static charges produced cannot be dissipated by purified water alone due to its low electrical conductivity. Therefore, in addition to cooling the tooling and the part to be machined, the coolant also has to ensure that an electrostatic charging is prevented or can be dissipated.

Various solutions are available in the prior art to prevent this electrostatic charge.

One option is to admix (solid) substances to the purified water used as a coolant, which dissolve in the water and increase the electrical conductivity. However, this may cause residues of the substances admixed to the cooling water to be left on the workpiece surface after mechanical machining. This is undesirable since these residues constitute impurities and may cause corrosion on the workpiece surface.

Furthermore, there are solutions in which carbon dioxide is introduced into purified water in a vessel under pressure. The carbon dioxide dissolves in the purified water, so that the electrical conductivity of the water increases. Subsequently, the water, mixed with carbon dioxide, from the pressure vessel is added to a coolant flow of purified water. The disadvantage here is that a pressure vessel and pipes are required for introducing the carbon dioxide. In addition, a certain proportion of the carbon dioxide is released from the purified water as soon as the vessel is opened, which means that the electrical conductivity no longer corresponds to the set value. Furthermore, such processes are often not sufficiently precise and involve a certain degree of inaccuracy. In this respect, in particular an overdosage of carbon dioxide may have an adverse effect and lead to increased corrosion of the workpiece.

### SUMMARY

Example embodiments provide a process and an apparatus that allow a precise enrichment of high-purity water with carbon dioxide. In addition, the process and the apparatus are intended to ensure that sufficient coolant is available on a permanent basis and that no or only a negligible change in the electrical conductivity can take place between production and use. Furthermore, it is intended that the apparatus should have as simple a setup as possible so that it can be provided cost-effectively and so as to be space-saving.

The object involved is achieved according to the present disclosure by a process for the continuous production of ultrapure water from a continuous stream of high-purity water by adding gas to the continuous flow of the water. The process includes the steps of:
(a) providing a continuous stream of high-purity water;
(b) introducing a gas into the continuous stream of high-purity water, wherein the gas in a state dissolved in the water increases the electrical conductivity of the water; subsequently
(c) causing the water mixed with gas to flow through a first mixer and mixing and dissolving the gas in the water as it flows through the first mixer to provide a water-gas solution;
(d) determining an electrical conductivity and/or an electrical resistance of the water-gas solution downstream of the first mixer and upstream of a point of supply of further gas into the water-gas solution;
(e) introducing further gas into the continuous stream of the water-gas solution at the supply point; subsequently
(f) causing the water-gas solution mixed with further gas to flow through a second mixer and mixing and dissolving the gas in the water-gas solution as it flows through the second mixer to further increase the electrical conductivity and reduce the electrical resistance;
(g) determining an electrical conductivity and/or an electrical resistance of the water-gas solution downstream of the second mixer; and
(h) controlling the amount of gas to be introduced in steps (b) and (e) as a function of at least one of the conductivity and the resistance determined in steps (d) and (g).

It is the fundamental idea of the present disclosure that owing to the continuous production of the ultrapure water, sufficient water having a desired electrical conductivity/electrical resistance is immediately and permanently available, in order, for example, to obviate electrostatic charges or to ensure that these charges can be eliminated. The high-purity water is conducted in a stream up to the tool and is enriched with gas on the way so as to become ultrapure water. The water thus flows continuously even while it is subjected to gas, rather than being filled into a container where it is treated with gas, and finally being conducted out of the container and to the tool.

Furthermore, the controlled, at least two-stage introduction of gas, based on the electrical conductivities/resistances determined, allows the desired electrical conductivity of the water-gas solution or the desired electrical resistance to be achieved as precisely as possible.

In addition, by having a flow through the mixers in steps (c) and (f), it is achieved that the gas is at least almost completely dissolved in the ultrapure water or in the water-gas solution. Moreover, a uniform distribution of the gas dissolved in the water is ensured.

Such a uniform distribution has an advantageous effect on the validity of the measurements of the electrical conductivity and/or the electrical resistance of the water-gas solution that are carried out downstream of the first and second mixers.

Determining the electrical conductivity or the resistance downstream of the first mixer and upstream of the point of supply of further gas makes it possible to determine whether the electrical conductivity/the resistance is within a desired range, so that in the event of too large a deviation, the amount introduced in step (e) can compensate for the undesirable deviation and at the same time a correction of the amount of gas introduced in step (b) takes place, so that after adjustment of the amount in step (b), the amount of gas introduced in step (e) has to be additionally subjected to a correction. Step (h) therefore makes a closed control loop possible so that the electrical conductivity of the water-gas solution downstream of the second mixer can be set as precisely as possible.

The second determination of the electrical conductivity/the resistance of the water-gas solution in step (g) downstream of the second mixer may also serve, for example, for controlling, in step (h), the amount of gas introduced.

The closed control loop allows to ensure that the electrical conductivity/the resistance of the ultrapure water produced (after a possible settling of the system) remains within comparatively narrow tolerances. In addition, the amount of gas is automatically adjusted if a change in the ambient conditions occurs.

One aspect of the present disclosure provides that the introduction of the gas in steps (b) and (e) is effected at a respectively associated supply point by a respective mass flow controller including the supply point. The mass flow controllers may perform the controlling in step (h) or be controlled by a central control unit. In this way, the mass flow controller combines several functions at once, thereby reducing complexity because the number of components required is reduced.

As an alternative to a mass flow controller, the introduction of the gas may be effected in each of steps (b) and (e) by a valve controlled in step (h). This also makes it possible to replace the valve individually and independently of the rest of the components. It is further possible to select the valve as a function of the amount of gas to be introduced.

The gas introduced in steps (b) and (e) may be carbon dioxide. In its dissolved state, carbon dioxide increases the electrical conductivity and reduces the electrical resistance of the water and features a dissolution behavior in water that can be well adjusted on the basis of temperature and pressure. Furthermore, as long as it is introduced into high-purity water only in small amounts, it can contribute to preventing corrosion from occurring on the workpiece.

The water-gas solution may be set into a laminar flow both after flowing through the first mixer and after flowing through the second mixer in steps (c) and (f), respectively. This laminar flow contributes to the measurement quality when determining the electrical conductivity/the resistance in steps (d) and (g). Furthermore, this can significantly reduce the settling distance, i.e. the distance between the mixer outlet and the sensor arranged downstream, which is required until the flow profile has been smoothed.

Preferably, such an amount of gas is added up to the point of the flow at which the water-gas solution is detected by means of step (g) that the water-gas solution has an electrical conductivity of 0.75-2 μS/cm or a corresponding electrical resistance. Such an electrical conductivity of the water is sufficient to prevent the build-up of a static electrical charge when cutting workpieces or to dissipate it. Furthermore, this range of electrical conductivity/electrical resistance corresponds to a gas quantity of carbon dioxide in the water at which corrosion on the parts to be machined can typically be ruled out.

The conductivity/electrical resistance determined in step (d) may be corrected in the event of a difference from a predefined setpoint value by adjusting the amount of gas supplied in step (b) and/or by adjusting the amount of gas supplied in step (e) using the controlling in step (h). Here, the predefined setpoint value allows an individual determination depending on the desired requirements. The closed control loop ensures that even if a parameter modification occurs due to external influences, the desired conductivity/electrical resistance of the water-gas solution will always be obtained by adjusting the amount of gas supplied.

In particular, the conductivity and/or the electrical resistance is/are set exclusively in the mixers, i.e. there is no admixing of water into this water-gas solution after the generated water-gas solution has been generated. This provides the advantage that the accuracy of the conductivity or the resistance can now no longer be influenced by any factors.

The present disclosure also relates to a process for cutting wafers, in which coolant is continuously fed to the wafer and the coolant is provided in the form of ultrapure water which is produced continuously by a process according to example embodiments, wherein preferably exclusively coolant produced in this way is used.

The object mentioned at the outset is further achieved by use of a continuous stream of ultrapure water generated by the process according to the invention as a directly used coolant in the mechanical cutting of parts, in particular wafers. This means that it is used directly without the employment of a storage container or the like for the ultrapure water. This ensures that the ultrapure water corresponds precisely to the specifications and that its electrical conductivity/its electrical resistance does not change as a result of an intermediate storage because, for example, the gas present in the water dissolves.

In addition, the use of the ultrapure water in the form of the water-gas solution ensures that no residues of the coolant whatsoever remain on the cut parts and also that no corrosion of these parts will develop.

Furthermore, the object mentioned at the outset is achieved by an apparatus for continuous production of ultrapure water and for carrying out the process according to the invention, including a flow channel having an inlet for introducing high-purity water, a first supply unit associated with the inlet for supplying gas into the flow channel, a first static mixer arranged in the flow channel downstream of the first supply unit, a first sensor downstream of the first mixer for measuring the electrical conductivity and/or the electrical resistance of a water-gas solution produced, a second supply unit arranged downstream of the first sensor for supplying further gas into the flow channel, a second mixer provided in the flow channel downstream of the second supply unit, and a second sensor for measuring the electrical conductivity and/or the electrical resistance of the water-gas solution downstream of the second mixer, and a control unit which is coupled to the first and second supply units and to the first and second sensors.

With regard to the resultant advantages, reference is made to the discussions above.

The first and second supply units may each be formed by a mass flow controller. This controller has the advantage that a plurality of functions are integrated in one component, so that the complexity of the apparatus is reduced since fewer individual components need to be installed.

Ideally, for example, an individual control unit becomes dispensable since it is part of the mass flow controller, so that the mass flow controller determines the amount of gas that is supplied to the water or the water-gas solution.

Furthermore, the mass flow controller may include an interface that is used for coupling, in terms of signaling, to the sensors for determining the electrical conductivity and/or the electrical resistance of the water-gas solution, so that the control unit of the mass flow controller can control the gas supply on the basis of the sensor signals.

As an alternative to this solution, in which the control unit is part of the mass flow controller, the control unit is a separate unit that controls both mass flow controllers and is coupled to the sensors.

Alternatively to the mass flow controllers, the first and second supply units may each include a controlled supply valve which supplements or limits the stream of gas supplied, the supply valves and the sensors being coupled to the control unit in terms of signaling. The supply valves are low-priced standard components that allow simple and reliable adjustment.

A flow straightener for generating a laminar flow may be provided downstream of the first mixer and upstream of the first sensor and/or downstream of the second mixer and upstream of the second sensor. This is a simple and low-cost component that can be installed in flow channels with little effort.

The flow straightener is used here to set the water-gas solution exiting the mixer into a laminar flow. In this way, no settling section at all is required downstream of the mixer in order to be able to determine a robust measurement signal with regard to the electrical conductivity and the electrical resistance.

This allows the area of the flow channel downstream of the mixers up to the respective sensor to be dimensioned shorter, as a result of which the apparatus can be produced using less material and requires less space.

The flow of generated water-gas solution emanating from the first mixer leads to the second supply unit without admixture of water.

Furthermore, the object mentioned at the outset is achieved by a device for cutting parts, including a mechanical saw and an apparatus according to the invention, wherein the cooling water pipe is coupled to the apparatus such that exclusively cooling water from the apparatus is directed into the cooling water pipe and the stream of continuously produced cooling water is supplied directly to the saw.

The water-gas solution used as cooling water is thus directed to the mechanical saw via the cooling water pipe without a storage container being interposed, so that the space requirement is reduced.

Owing to the direct supply of the cooling water and immediate use in the cutting area of the saw, there is practically no modification of the water-gas solution due to degassing processes.

It is further conceivable here that the amount of coolant, and therefore also the amount of gas dissolved in the water, can be adjusted according to requirements. This means that if a large amount of coolant is needed, the mass flow rate of the high-purity water fed into the apparatus is increased and the amount of the gas is adjusted accordingly by the supply units. If the amount of coolant required is low, the mass flow rate of the high-purity water flowing in is reduced accordingly and the amount of gases introduced by the supply units is reduced along with it.

The flow of the generated water-gas solution emanating from the first and second mixers is directed to the saw without admixture of water.

### BRIEF DESCRIPTION OF DRAWINGS

The present disclosure will be described below with reference to an embodiment which is illustrated in the accompanying drawing, in which:

FIG. 1 shows a schematic drawing of a setup including the apparatus according to the invention, by means of which the process according to the invention is carried out, and the device according to the invention.

### DETAILED DESCRIPTION

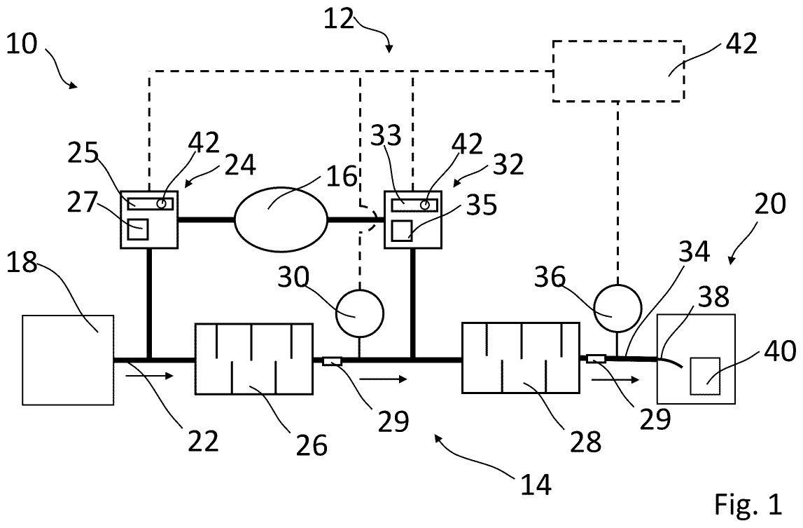

FIG. 1 shows a setup 10 including an apparatus 12 for producing ultrapure water, the apparatus 12 comprising a flow channel 14 along which high-purity water is enriched with gas from a gas source 16. The gas is selected such that, when dissolved in water, it increases the electrical conductivity thereof and reduces the electrical resistance.

The flow channel 14 is coupled to a water source 18 by means of which the apparatus 12 is supplied with high-purity water, which flows along the flow channel 14 (see arrows in FIG. 1) and is directed to a device 20 for cutting parts.

The water source 18 may be a tank filled with high-purity water.

Alternatively, it is also conceivable that the water source 18 is an installation in which water is demineralized, degassed and, for example, freed from a large portion of the ions present in the water by a membrane process, so that high-purity water can be provided.

The flow channel 14 comprises an inlet 22 which is used to introduce the high-purity water of the water source 18 into the apparatus 12.

Assigned to the inlet 22 is a first supply unit 24 for gas, which is coupled to the gas source 16.

According to one option, the first supply unit 24 may be a mass flow controller 25. The mass flow controller 25 here comprises a valve, an integrated control, a mass flowmeter and at least one interface via which measuring signals can be picked up.

A second option provides that the mass flow controller 25 is coupled by its interface to a central control unit 42 and receives control commands via the latter.

According to a third option, the supply unit 24 may be a supply valve 27.

Furthermore, the flow channel 14 comprises a first static mixer 26 which is arranged downstream of the inlet 22 and is connected via the flow channel 14 to a second static mixer 28 arranged downstream.

Provided at the flow outlet of the first and second static mixers 26, 28 or immediately downstream of the two mixers 26, 28 is a respective flow straightener 29, which is the case optionally.

A first sensor 30 is seated at the section of the flow channel 14 that connects the first and second static mixers 26, 28 to each other. Arranged downstream of the first sensor 30 is a second supply unit 32 which, like the first supply unit 24, is coupled to the gas source 16.

By analogy with the first supply unit 24, the second supply unit 32 may also be a mass flow controller 33 according to the first option and a supply valve 35 according to a third option.

Downstream of the second static mixer 28, the flow channel 14 has an outlet 34, upstream of which a second sensor 36 is arranged. In addition, the outlet 34 is coupled to the device 20 for the cutting of parts.

Within the device 20, the ultrapure water leaving the apparatus 12 is provided via a cooling water pipe 38 associated with the device 20 in the cutting area of a mechanical saw 40.

Furthermore, the apparatus 12 comprises a control unit 42.

According to the first option mentioned above, the two mass flow controllers 25, 33 have their own integrated controller unit which then receives data on the electrical conductivity or the electrical resistance of the water-gas solution from its respective associated sensor 30, 36 and controls the supply of gas.

It is also possible to couple the two integrated control units to each other in order to achieve communication and coordination between the control units.

According to the second option, the mass flow controllers 25, 33 are controlled by the central control unit 42.

According to the third option, in which the first and second supply units 24, 32 are supply valves 27, 35, there is also a separate, central control unit 42 which is coupled to the first and second supply units 24, 32 and to the first and second sensors 30, 36 (shown in the drawing by dashed lines).

Based on the above discussions regarding the apparatus, the process for the continuous production of ultrapure water will be explained below with reference to FIG. 1.

In the process, carbon dioxide is introduced into a continuous stream of high-purity water in two stages in a controlled manner. Here, the carbon dioxide when in the dissolved state increases the electrical conductivity and lowers the electrical resistance of the water, so that the water-gas solution can prevent or remove electrical charges that may build up during mechanical cutting of parts, e.g. wafers.

For this purpose, high-purity water flows continuously from the water source 18 into the inlet 22 of the flow channel 14 up to the saw 40. Carbon dioxide is introduced into the continuous stream of high-purity water by means of the first supply unit 24.

Upon entry into the first mixer 26, a mixing of the carbon dioxide with the water occurs, in which the gas dissolves in the water so that a water-gas solution is provided. Downstream of the mixer, the water-gas solution flows through the flow straightener 29, so that a laminar flow profile is produced, which has a positive effect on the measurement quality of the first sensor 30.

The first sensor 30 is used to determine the electrical conductivity or the electrical resistance of the water-gas solution. The measured value acquired in the process is provided in the form of signals to the two control units 42 integrated in the mass flow controllers 25, 33 or to the separately implemented central control unit 42.

The second supply unit 32 introduces further carbon dioxide into the water-gas solution.

Following this, the water-gas solution mixed with gas flows through the second static mixer 28, so that the newly added gas is mixed with, and dissolved in, the water-gas solution, as a result of which the electrical conductivity of the water-gas solution increases further or the electrical resistance decreases accordingly.

Downstream of the second static mixer 28, the water-gas solution flows through the flow straightener 29 and is again set into a laminar flow.

Downstream of the flow straightener 29, a further measurement of the electrical conductivity/the electrical resistance of the water-gas solution is carried out by the second sensor 36. These measured values are also available at least to the control unit integrated in the mass flow controller 33 or to the separately implemented control unit 42 in the form of signals.

The integrated control units or the separately implemented control unit 42 here permanently control(s) the amount of gas introduced by the first and second supply units 24, 32, based on the electrical conductivities or the electrical resistance of the water-gas solution, which are determined by the first sensor 30 and the second sensor 36.

For the electrical conductivities or electrical resistances that are to exist at the sensors 30, 36, predefined setpoint values are specified, which are adjustable. The control can be effected here both as a function of the specific differences from the setpoint values and/or the change with time of the differences from the setpoint values.

In this process, in the first stage an appropriately large amount of carbon dioxide is to be introduced into the high-purity water by the first supply unit so that the measured electrical conductivity at the first sensor 30 approximately corresponds to a setpoint value of 0.2 μS/cm and the electrical resistance corresponds to a corresponding reciprocal value.

In the second stage of the process, the amount of carbon dioxide introduced by means of the second supply unit 32 is controlled in such a way that the electrical conductivity captured by the second sensor 36 is in the range of from 0.75 to 2 μS/cm and the electrical resistance is a corresponding reciprocal value.

If the control unit(s) 42 determine(s) that the electrical conductivity/electrical resistance of the water-gas solution as captured by the first sensor 30 deviates from a predefined setpoint value, which is adjustable, the control unit 42 increases or decreases the amount of carbon dioxide introduced by the first supply unit 24 as required.

In addition, the control unit(s) 42 at the same time also adjust(s) the amount of gas introduced by the second supply unit 32 in order to correct a deviation from the predefined setpoint value, so that finally the electrical conductivity/the electrical resistance of the water-gas solution downstream of the second static mixer 28 exhibits the desired electrical conductivity/electrical resistance.

Furthermore, it is conceivable that if the electrical conductivity or the electrical resistance determined by the second sensor 36 shows too large a difference from the predefined setpoint value, the water-gas solution is not made available to the device 20, but is discharged. This ensures that no cooling water whatsoever is provided that does not meet the specifications. This is useful especially at the beginning of the process, since the process may possibly have to settle or stabilize until the desired electrical conductivities/resistances are provided at the first and second sensors 30, 36. It may therefore be advantageous to start the process but wait until the ultrapure water used as cooling water satisfies the specifications before using the device 20 for sawing.

Basically, it is also conceivable to add any desired number of further stages so that the introduction of carbon dioxide is carried out using more than two stages.

The conductivity and/or the electrical resistance are set in particular exclusively in the mixers, i.e. there is no admixture of water into this water-gas solution after the generated water-gas solution has been generated. This provides the advantage that the accuracy of the conductivity or the resistance can now no longer be influenced by any factors. This water-gas solution alone (without a subsequent admixing of water) is then preferably also conducted to the device for cutting and used there in the cutting of wafers.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A process for the continuous production of ultrapure water from a continuous stream of high-purity water by adding gas to the continuous flow of the water, the process comprising:
a) providing a continuous stream of high-purity water;
b) introducing a gas into the continuous stream of high-purity water, wherein the gas in a state dissolved in the water increases the electrical conductivity of the water and reduces the electrical resistance thereof;
c) causing the water mixed with gas to flow through a first mixer and mixing and dissolving the gas in the water as it flows through the first mixer to provide a water-gas solution;
d) determining an electrical conductivity and/or an electrical resistance of the water-gas solution downstream of the first mixer and upstream of a point of supply of further gas into the water-gas solution;
e) introducing further gas into the continuous stream of the water-gas solution at the supply point;
f) causing the water-gas solution mixed with further gas to flow through a second mixer and mixing and dissolving the gas in the water-gas solution as it flows through the second mixer to further increase the electrical conductivity and reduce the electrical resistance;
g) determining an electrical conductivity and/or an electrical resistance of the water-gas solution downstream of the second mixer; and
h) controlling the amount of gas to be introduced in steps (b) and (e) as a function of at least one of the conductivity and the electrical resistance determined in steps (d) and (g).

2. The process according to claim 1, wherein the introduction of the gas in steps (b) and (e) is effected at a respectively associated supply point by a respective mass flow controller including the supply point, which either perform the controlling in step (h) or are controlled by a central control unit.

3. The process according to claim 1, wherein the introduction of the gas in each of steps (b) and (e) is effected by a valve controlled in step (h).

4. The process according to claim 1, wherein the gas introduced in steps (b) and (e) is carbon dioxide.

5. The process according to claim 1, wherein the water-gas solution is set into a laminar flow both after flowing through the first mixer and after flowing through the second mixer in steps (c) and (f), respectively.

6. The process according to claim 1, wherein so much gas is added up to the point of the flow at which the water-gas solution is detected for step (g) that the water-gas solution has an electrical conductivity of 0.75-2 μS/cm.

7. The process according to claim 1, wherein when there is a difference from a predefined setpoint value, the conductivity/electrical resistance determined in step (d) is corrected by means of the controlling in step (h) by adjusting the amount of gas supplied in step (b) and/or by adjusting the amount of gas supplied in step (e).

8. The process according to claim 1, wherein the conductivity and/or the electrical resistance is/are set exclusively in the mixers.

9. Use of a continuous stream of ultrapure water generated by a process according to claim 1 as a directly used coolant in the mechanical cutting of parts.

10. An apparatus for continuous production of ultrapure water and for carrying out the process according to claim 1, comprising a flow channel having an inlet for introducing high-purity water, a first supply unit associated with the inlet for supplying gas into the flow channel, a first static mixer arranged in the flow channel downstream of the first supply unit, a first sensor downstream of the first mixer for measuring the electrical conductivity and/or the electrical resistance of a water-gas solution produced, a second supply unit arranged downstream of the first sensor for supplying further gas into the flow channel, a second mixer provided in the flow channel downstream of the second supply unit, and a second sensor for measuring the electrical conductivity and/or the electrical resistance of the water-gas solution downstream of the second mixer, and a control unit which is coupled to the first and second supply units and to the first and second sensors.

11. The apparatus according to claim 10, wherein the first and second supply units are each formed by a mass flow controller.

12. The apparatus according to claim 10, wherein the first and second supply units each include a controlled supply valve which limits the stream of gas supplied, the supply valves and the sensors being coupled to the control unit in terms of signaling.

13. The apparatus according to claim 10, wherein a flow straightener for generating a laminar flow is provided downstream of the first mixer and upstream of the first sensor and/or downstream of the second mixer and upstream of the second sensor.

14. The apparatus according to claim 10, wherein the flow of generated water-gas solution emanating from the first mixer is led to the second supply unit without admixture of water.

15. A device for cutting parts, comprising a mechanical saw and an apparatus according to claim 10, wherein the cooling water pipe is coupled to the apparatus such that exclusively cooling water from the apparatus is directed into the cooling water pipe and the stream of continuously produced cooling water is supplied directly to the saw.

16. The device according to claim 15, wherein the flow of the generated water-gas solution emanating from the first and second mixers is directed to the saw without admixture of water.
